(19) United States
(12) Patent Application Publication
(10) Pub. No.: US 2026/0167518 A1
(43) Pub. Date: Jun. 18, 2026

(54) DIRECT SYNTHESIS OF NICKEL-RICH MONOCRYSTALLINE NMC FROM A TRANSITION METAL HYDROXIDE PRECURSOR AND A LITHIUM COMPOUND

(71) Applicant: Battelle Memorial Institute, Richland, WA (US)

(72) Inventors: Jie Xiao, Richland, WA (US); Bingbin Wu, Richland, WA (US)

(21) Appl. No.: 19/415,389

(22) Filed: Dec. 10, 2025

Related U.S. Application Data
(60) Provisional application No. 63/735,728, filed on Dec. 18, 2024.

(51) Int. Cl. C01G 53/504; H01M 10/0525

(52) U.S. Cl. CPC C01G 53/504; H01M 10/0525; C01P 2002/52; C01P 2004/61; C01P 2006/40

(57) ABSTRACT

Aspects of a one-step method for synthesizing monocrystalline LiNiₓMn_{y}M_{z}Co_{1-x-y-z}O₂ include heating a solid hydroxide precursor comprising NiₓMn_{y}M_{z}Co_{1-x-y-z}(OH)₂ and a molar excess of a lithium compound in an oxygen-containing atmosphere at a temperature T for an effective period of time t to form monocrystalline lithium nickel manganese cobalt oxide (NMC) having a formula LiNiₓMn_{y}M_{z}Co_{1-x-y-z}O₂. In the formula, M represents one or more dopant metals, 0.6≤x<1, 0.01≤y<0.2, 0≤z≤0.05, and x+y+z≤1.0. The synthesized monocrystalline NMC is useful as an active material for cathodes, such as cathodes for lithium ion and lithium metal batteries.

### CROSS REFERENCE TO RELATED APPLICATIONS

This application claims the benefit of and priority to the earlier filing date of U.S. Provisional Application No. 63/735,728, filed Dec. 18, 2024, which is herein incorporated by reference in its entirety.

### ACKNOWLEDGMENT OF GOVERNMENT SUPPORT

This invention was made with Government support under Contract DE-AC05-76RL01830 awarded by the U.S. Department of Energy. The Government has certain rights in the invention.

### FIELD

Methods of synthesizing monocrystalline oxide materials are disclosed, as well as cathodes including the crystalline oxide materials and lithium ion batteries including the cathodes.

### SUMMARY

This disclosure concerns aspects of methods for synthesizing monocrystalline oxide materials, as well as cathodes including the crystalline oxide materials, and batteries including the cathodes.

Advantageously, in some aspects, monocrystalline lithium nickel manganese cobalt oxide (NMC) is directly synthesized in a one-step method from a transition metal hydroxide precursor and a lithium compound. In any of the following aspects, single crystals of the NMC may have a mean particle size of from 1 μm to 5 μm.

In some aspects, the method includes synthesizing LiNiₓMn_{y}M_{z}Co_{1-x-y-z}O₂ by heating a solid hydroxide precursor comprising NiₓMn_{y}M_{z}Co_{1-x-y-z}(OH)₂ and a molar excess of a lithium compound in an oxygen-containing atmosphere at a temperature T for an effective period of time t to form monocrystalline NMC having a formula LiNiₓMn_{y}M_{z}Co_{1-x-y-z}O₂. In the formula, M represents one or more dopant metals, 0.6≤x<1, 0.01≤y<0.2, 0:5≤z≤0.05, and x+y+z≤1.0. In certain aspects, x+y+z<1.0. In some implementations, z=0, and the NMC is not doped. In other implementations, z>0 and the NMC is doped. In certain implementations, the dopant metal M comprises Mg, Ti, Al, Zn, Fe, Zr, Sn, Sc, V, Cr, Cu, Ga, Y, Nb, Mo, Ru, Ta, W, Ir, or any combination thereof.

In any of the foregoing or following aspects, the solid hydroxide precursor and the lithium compound may be heated in the oxygen-containing atmosphere to the temperature Tat a ramping rate of from 2° C./minute to 10° C./minute. In some aspects, the solid hydroxide precursor and the lithium compound are heated under an O₂ flow at a flow rate of 0 cm³/minute to 500 cm³/minute.

In any of the foregoing or following aspects, the lithium compound may comprise lithium oxide, lithium hydroxide, lithium carbonate, or any combination thereof. In some implementations, a lithium compound to solid hydroxide precursor molar ratio (lithium compound:solid hydroxide precursor) is from 1.05:1 to 5:1.

In any of the foregoing or following aspects, the temperature T may be from 850° C. to 1000° C.

In some aspects, the time t is from 1 minute to 12 hours. In some aspects, the method further includes cooling the monocrystalline NMC from the temperature T to ambient temperature at a temperature reduction rate of from 2° C./minute to 10° C./minute.

In any of the foregoing aspects, the one-step synthesis may be followed by one or more post-synthesis processes, such as washing the monocrystalline NMC with water to provide washed monocrystalline NMC, drying the washed monocrystalline NMC at a temperature of from 40° C. to 80° C. under vacuum to provide dried monocrystalline NMC, heating the dried monocrystalline NMC at a temperature of from 500° C. to 600° C. for a time of from 1 hour to 10 hours, and subsequently cooling the dried monocrystalline NMC to ambient temperature to form heat treated monocrystalline NMC.

The foregoing and other objects, features, and advantages of the present disclosure will become more apparent from the following detailed description, which proceeds with reference to the accompanying figures.

### BRIEF DESCRIPTION OF THE DRAWINGS

FIG. 1 is a schematic diagram of an exemplary lithium ion battery.

FIG. 2 is a schematic side elevation view of an exemplary simplified pouch cell.

FIGS. 3A-3C are scanning electron microscopy (SEM) images of the as-synthesized, ground, washed, and dried NMC (left image) and after crushing (right image) LiNi_{0.8}Mn_{0.1}Co_{0.1}O₂ (NMC811) prepared with Li₂O at 900° C. for 10 hours (FIG. 3A), 920° C. for 2 hours (FIG. 3B), or 980° C. for 1 minute (FIG. 3C); size bar=5 μm.

FIG. 4 is a graph showing charge-discharge curves in Li/NMC811 half cells with the NMC products prepared with Li₂O at 900° C., 920° C., and 980° C.; voltage range is 2.7-4.4 V.

FIG. 5 is a graph showing charge-discharge curves in graphite/NMC811 full cells with the NMC products prepared with Li₂O at 900° C., 920° C., and 980° C.; voltage range is 2.6-4.3 V.

FIG. 6 is a graph showing the cycling performance of the NMC products prepared with Li₂O at 900° C., 920° C., and 980° C. in graphite/NMC811 full cells; voltage range is 2.6-4.3 V.

FIGS. 7A-7C are SEM images of the as-synthesized (left image) and crushed (right image) LiNi_{0.8}Mn_{0.1}Co_{0.1}O₂ (NMC811) prepared with Li₂CO₃ (FIG. 7A), LiOH (FIG. 7B), and Li₂O (FIG. 7C) at 980° C. for 1 minute; size bar=5 μm.

FIG. 8 is a graph showing charge-discharge curves in Li/NMC811 half cells with the NMC products prepared with Li₂CO₃, LiOH, and Li₂O at 980° C.; voltage range is 2.7-4.4 V.

FIG. 9 is showing charge-discharge curves in graphite/NMC811 full cells with the NMC products prepared with Li₂CO₃, LiOH, and Li₂O at 980° C.; voltage range is 2.6-4.3 V.

FIG. 10 is a graph showing the cycling performance of the NMC products prepared with Li₂CO₃, LiOH, and Li₂O at 980° C. in graphite/NMC811 full cells; voltage range is 2.6-4.3 V.

### DETAILED DESCRIPTION

Nickel-rich lithium manganese cobalt oxide (NMC) cathodes (LiNiₓMn_{y}Co_{1-x-y}O₂) are promising cathodes for next generation lithium ion batteries. Such batteries may be used, for example, for long range electrical vehicles. In particular, NMC cathodes where 0.6≤x<1, the capacity is ≥200 mAh/g, and the cathode is operable at high voltage (>3.8 V) are desirable.

Traditionally, NMC cathodes are prepared by coprecipitation methods, which provide aggregation of nano-sized primary particles into micro-sized secondary polycrystalline particles. This aggregated particle structure shortens the diffusion length of the primary particles and increases the number of pores and grain boundaries within the secondary particles, which accelerates the electrochemical reaction and improves the rate capability of NMC. Secondary micron-sized particles formed of agglomerated nano-sized primary particles are the most common morphology for conventional NMC cathodes. However, as the Ni content (i.e., the value of x) increases above 0.6, challenges arise. For example, such Ni-rich NMC cathodes are subject to moisture sensitivity, aggressive side reactions, and/or gas generation during cycling, raising safety concerns. These challenges are attributable to the large surface area of the secondary particles. Additionally, while creating spherical secondary polycrystalline NMC particles reduces the surface/volume ratio, pulverization along the weak internal grain boundaries is generally observed after cycling. These cracks are induced by the non-uniform volume change of primary particles during cycling and exacerbated by the anisotropy among individual particles and grains in the polycrystalline NMC. The intergranular cracking exposes new surfaces to electrolyte for side reactions, which accelerates cell degradation. As the Ni content becomes ≥0.8 in NMC particles, the major challenge in Ni-rich NMC cathodes becomes quite different from those in conventional NMC cathodes. For example, NMC811 (LiNi_{0.8}Mn_{0.1}Co_{0.1}O₂) is very sensitive to moisture, which creates challenges for manufacturing, storing and transporting the Ni-rich NMC particles/cathodes. Also, after extensive cycling, gas generation by the side reactions raises safety concerns.

This disclosure concerns aspects of one-step methods for directly synthesizing single crystalline Ni-rich cathode materials. Some aspects of the disclosed methods may be used for synthesizing large batches, e.g., 1 kg or more, of single crystal NMC. In some implementations, the single crystalline Ni-rich cathodes comprise monocrystalline NMC. In some implementations, the monocrystalline NMC has a formula LiNiₓMn_{y}M_{z}Co_{1-x-y-z}O₂, where M represents one or more dopant metals, 0.6≤x<1, 0.01≤y<0.2, 0<z:5 0.05, and x+y+z:5 1.0. When x+y+z=1.0, Co is absent and the material has a formula LiNiₓMn_{y}M_{z}O₂. When z>0, the NMC is a doped NMC. As used hereinafter, the term NMC may refer to undoped or doped NMC unless otherwise stated. In certain aspects, single crystalline Ni-rich cathodes comprising the monocrystalline NMC include reduced surface areas, phase boundaries, and/or more integrated crystal structures compared to polycrystalline cathodes. Advantageously, the one-step method reduces the process time, reduces energy usage, and is more cost effective. In certain implementations, the one-step process has an annealing time of less 10 minutes, less than 5 minutes, or even an annealing time of just 1-2 minutes. Additionally, some aspects of the single crystalline Ni-rich cathodes exhibit excellent capacity retention during long-term cycling. For example, the single crystalline Ni-rich cathodes may have a discharge specific capacity retention of >80% after 600 cycles, >85% after 600 cycles, >80% after 700 cycles, or even >75% after 750 cycles. Aspects of the single crystalline Ni-rich cathodes made by the disclosed methods may be operable at high voltages, such as voltages >3.8 V.

### I. Definitions and Abbreviations

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

The disclosure of numerical ranges should be understood as referring to each discrete point within the range, inclusive of endpoints, unless otherwise noted. Unless otherwise indicated, all numbers expressing quantities of components, percentages, temperatures, times, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing aspects from discussed prior art, the aspect numbers are not approximates unless the word “about” is recited.

Although there are alternatives for various components, parameters, operating conditions, etc. set forth herein, that does not mean that those alternatives are necessarily equivalent and/or perform equally well. Nor does it mean that the alternatives are listed in a preferred order unless stated otherwise.

Definitions of common terms in chemistry may be found in Richard J. Lewis, Sr. (ed.), Hawley's Condensed Chemical Dictionary, published by John Wiley & Sons, Inc., 2016 (ISBN 978-1-118-13515-0).

In order to facilitate review of the various aspects of the disclosure, the following explanations of specific terms are provided:

Active salt: As used herein, the term “active salt” refers to a salt that significantly participates in electrochemical processes of electrochemical devices. In the case of batteries, the electrochemical process refers to charge and discharge processes contributing to the energy conversions that ultimately enable the battery to deliver/store energy. As used herein, the term “active salt” refers to a salt that constitutes at least 5% of the redox active materials participating in redox reactions during battery cycling after initial charging.

Annealing: A process in which a material is heated to a specified temperature for a specified period of time and then gradually cooled. The annealing process may remove internal strains from previous operations and can eliminate distortions and imperfections to produce a stronger and more uniform material.

Anode: An electrode through which electric charge flows into a polarized electrical device. From an electrochemical point of view, negatively-charged anions move toward the anode and/or positively-charged cations move away from it to balance the electrons leaving via external circuitry.

Areal capacity or specific areal capacity is the capacity per unit area of the electrode (or active material) surface and is typically expressed in units of mAh cm⁻².

Capacity: The capacity of a battery is the amount of electrical charge a battery can deliver. The capacity is typically expressed in units of mAh, or Ah, and indicates the maximum constant current a battery can produce over a period of one hour. For example, a battery with a capacity of 100 mAh can deliver a current of 100 mA for one hour or a current of 5 mA for 20 hours.

Cathode: An electrode through which electric charge flows out of a polarized electrical device. From an electrochemical point of view, positively charged cations invariably move toward the cathode and/or negatively charged anions move away from it to balance the electrons arriving from external circuitry.

Cell: As used herein, a cell refers to an electrochemical device used for generating a voltage or current from a chemical reaction, or the reverse in which a chemical reaction is induced by a current. Examples include voltaic cells, electrolytic cells, and fuel cells, among others. A battery includes one or more cells. The terms “cell” and “battery” are used interchangeably when referring to a battery containing only one cell.

Coulombic efficiency (CE): The efficiency with which charges are transferred in a system facilitating an electrochemical reaction. CE may be defined as the amount of charge exiting the battery during the discharge cycle divided by the amount of charge entering the battery during the charging cycle.

Current density: A term referring to the amount of current per unit area. Current density is typically expressed in units of mA/cm².

Electrolyte: A substance containing free ions that behaves as an electrically conductive medium. Electrolytes generally comprise ions in a solution, but molten electrolytes and solid electrolytes also are known.

NMC: lithium nickel manganese cobalt oxide.

One-step method: As used herein, the term “one-step method” refers to a one-step synthesis of NMC. The term one-step method does preclude one or more post-synthesis steps, such as washing and drying the product.

Precursor: A precursor participates in a chemical reaction to form another compound. As used herein, the term “precursor” refers to metal-containing compounds used to prepare lithium nickel manganese cobalt oxide and metal-doped lithium nickel manganese cobalt oxide.

Separator: A battery separator is a porous sheet or film placed between the anode and cathode. It prevents physical contact between the anode and cathode while facilitating ionic transport.

Solid state: Composed of solid components. As defined herein, a solid-state synthesis proceeds with solid components directly without using liquids (e.g., solvents) or sintering agents.

Specific capacity: A term that refers to capacity per unit of mass. Specific capacity may be expressed in units of mAh/g, and often is expressed as mAh/g carbon when referring to a carbon-based electrode in Li/air batteries.
TM: transition metal
TMOH: transition metal hydroxide
TMO: transition metal oxide

### II. Synthesis of Crystalline Oxide Materials

This disclosure concerns aspects of methods for synthesizing NMC and doped variants thereof.

In some aspects, the NMC has a LiNiₓMn_{y}M_{z}Co_{1-x-y-z}O₂, where M represents one or more dopant metals, 0.6≤x<1, 0.01≤y<0.2, 0<z≤0.05, and x+y+z 5 1.0. In some implementations, the synthesis of LiNiₓMn_{y}M_{z}Co_{1-x-y-z}O₂ is a direct, one-step process.

Some aspects of a method for synthesizing monocrystalline NMC include heating a solid hydroxide precursor comprising NiₓMn_{y}M_{z}Co_{1-x-y-z}(OH)₂ and a molar excess of a lithium compound in an oxygen-containing atmosphere at a temperature T for an effective period of time t to form monocrystalline NMC having a formula LiNiₓMn_{y}M_{z}Co_{1-x-y-z}O₂, wherein x, y, and z are as defined above. Advantageously, the synthesis is a one-step process that includes a single heating step and does not require an initial conversion of a solid hydroxide precursor to a solid oxide precursor. Moreover, as discussed in detail below, the effective period of time in some aspects is less than 2 hours and may be as short as one minute. The method is a solid-state process that includes no liquid starting components, e.g., no liquid solvents or reagents. In other words, all components are in the solid phase at the start of the synthesis. In any of the foregoing or following aspects, the lithium compound may comprise, consist of, or consist essentially of lithium oxide (Li₂O), lithium hydroxide (LiOH or LiOH·H₂O), lithium carbonate (Li₂CO₃), lithium peroxide (Li₂O₂), or any combination thereof. In some aspects, the lithium compound comprises, consists of, or consists essentially of lithium oxide, lithium hydroxide, or a combination thereof. As used herein, the term “consists essentially of” means that the lithium compound does not include appreciable amounts (e.g., 1 wt % or more) of any lithium compound not recited. In certain implementations, the lithium compound is lithium oxide. In some aspects, the oxygen-containing atmosphere is pure or substantially pure oxygen, e.g., >98 wt % O₂ or >99 wt % O₂.

In any of the foregoing or following aspects, the method may further include a pre-synthesis process of combining the solid hydroxide precursor comprising NiₓMn_{y}M_{z}Co_{1-x-y-z}(OH)₂ and the molar excess of the lithium compound under an inert atmosphere (e.g., argon, helium, or nitrogen) prior to heating in the oxygen-containing atmosphere. As used herein, the term “combining” may refer to (i) mixing the solid hydroxide precursor and the lithium compound in a vessel, or (ii) placing the solid hydroxide precursor and the lithium compound (e.g., Li₂O) in a vessel without mixing the two components. In some aspects, the solid hydroxide precursor and the lithium compound are mixed to form a hydroxide mixture. In some aspects, the inert atmosphere comprises or consists of argon. In any of the foregoing or following aspects, a lithium compound:solid hydroxide precursor molar ratio may be from 1:05:1 to 5:1, such as within a range having endpoints selected from 1:05:1, 1.1:1, 1.15:1, 1.2:1, 1.25:1, 1.3:1, 1.4:1, 1.5:1, 2:1, 3:1, 4:1, and 5:1. In some aspects, the lithium compound:solid hydroxide precursor molar ratio is from 1:05:1 to 4:1, 1:05:1 to 3:1, 1:05:1 to 2:1, 1:05:1 to 1.5:1, 1:05:1 to 1.2:1, 1:05:1 to 1.15:1, or 1.08:1 to 1.12:1. In certain implementations, the lithium compound:solid hydroxide precursor molar ratio is from 1.05:1 to 1.2:1.

When the solid components are mixed to form a hydroxide mixture, the hydroxide mixture may be mixed for a period of time prior to heating at the temperature T for the effective period of time t. In some aspects, the hydroxide mixture is mixed for a time of from 1 hour to 5 hours, such as a time within a range having endpoints selected from 1 hour, 2 hours, 3 hours, 4 hours, or 5 hours, e.g., from 1 hour to 3 hours.

In any of the foregoing or following aspects, the temperature T may be from 850° C. to 1000° C., such as within a range having endpoints selected from 850° C., 860° C., 870° C., 880° C., 890° C., 900° C., 910° C., 920° C., 930° C., 940° C., 950° C., 960° C., 970° C., 980° C., 990° C., and 1000° C. In some aspects, the temperature T is from 870° C. to 1000° C., from 900° C. to 1000° C., from 910° C. to 1000° C., from 920° C. to 1000° C., from 920° C. to 990° C., or from 920° C. to 980° C. In certain aspects, the temperature T is from 920° C. to 1000° C., such as from 920° C. to 980° C.

In any of the foregoing or following aspects, the time t may be from 30 seconds to 15 hours, such as within a range having endpoints selected from 30 seconds, 1 minute, 1.5 minutes, 2 minutes, 3 minutes, 4 minutes, 5 minutes, 10 minutes, 15 minutes, 30 minutes, 45 minutes, 1 hour, 1.5 hours, 2 hours, 2.5 hours, 3 hours, 5 hours, 7 hours, 10 hours, 12 hours, and 15 hours. In some aspects, the time t is from 1 minute to 12 hours, or from 1 minute to 10 hours. In some implementations the time t is from 1 minute to 10 hours when the temperature T is from 900° C. to 1000° C. In certain implementations, the time t is from 1 minute to 2 hours when the temperature T is from 920° C. to 1000° C., or from 920° C. to 980° C. In other implementations, the time t is from 1 minute to 1 hour when the temperature T is from 950° C. to 1000° C., or from 950° C. to 980° C. It is understood that the time t and temperature T are inversely correlated. Thus, a shorter time t may be used when the temperature T is higher. In certain working examples, a hydroxide mixture comprising the solid hydroxide precursor and the lithium compound was heated in the oxygen-containing atmosphere at 900° C. for 10 hours, 920° C. for 2 hours, or 980° C. for 1 minute.

In any of the foregoing or following aspects, heating the solid hydroxide precursor and the lithium compound in the oxygen-containing atmosphere may comprise heating the solid hydroxide precursor and the lithium compound under an 02 flow at a flow rate of 0 cm³/minute to 500 cm³/minute, such as a flow rate within a range having endpoints selected from 50 cm³/minute, 100 cm³/minute, 150 cm³/minute, 200 cm³/minute, 250 cm³/minute, 300 cm³/minute, 400 cm³/minute, and 500 cm³/minute. In some aspects, the flow rate is 100 cm³/minute to 500 cm³/minute, 100 cm³/minute to 300 cm³/minute, or 150 cm³/minute to 250 cm³/minute. In some implementations, the solid hydroxide precursor and the lithium compound are heated in a furnace, and the solid hydroxide precursor and the lithium compound are held in the furnace at ambient temperature for a period of time (e.g., 30-90 minutes) under 02 flow to replace all atmosphere (e.g., an inert atmosphere, such as argon, and/or air) in the furnace with oxygen. In any of the foregoing or following aspects, the solid hydroxide precursor and the lithium compound may be heated in the oxygen-containing atmosphere to the temperature Tat a ramping rate of from 2° C./minute to 10° C./minute, such as a ramping rate within a range having endpoints selected from 2° C./minute, 3° C./minute, 4° C./minute, 5° C./minute, 6° C./minute, 7° C./minute, 8° C./minute, 9° C./minute, and 10° C./minute. In some implementations, the ramping rate is from 3° C./minute to 7° C./minute, or a ramping rate of from 4° C./minute to 6° C./minute. In some examples, the ramping rate was 5° C./minute.

In any of the foregoing or following aspects, the monocrystalline NMC may be cooled from the temperature T to ambient temperature at a temperature reduction or cooling rate of from 2° C./minute to 10° C./minute, such as a cooling rate within a range having endpoints selected from 2° C./minute, 3° C./minute, 4° C./minute, 5° C./minute, 6° C./minute, 7° C./minute, 8° C./minute, 9° C./minute, and 10° C./minute. In some aspects, the cooling rate is from 3° C./minute to 7° C./minute, or a cooling rate of from 4° C./minute to 6° C./minute. In some examples, the cooling rate was 5° C./minute.

In any of the foregoing or following aspects, the one-step synthesis may be followed by one or more post-synthesis processes. In some aspects, the post-synthesis processes may comprise (i) washing the monocrystalline NMC with water to provide washed monocrystalline NMC; (ii) drying the washed monocrystalline NMC at a temperature of from 40° C. to 80° C. under vacuum to provide dried monocrystalline NMC; (iii) heating the dried monocrystalline NMC at a temperature of from 500° C. to 600° C. for a time of from 1 hour to 10 hours; and (iv) subsequently cooling the dried monocrystalline NMC to ambient temperature. The foregoing post-synthesis process may be useful when a lithium/transition metal (Li/TM) molar ratio is <1.1. In some aspects, the washed monocrystalline NMC is dried under vacuum at a temperature within a range having endpoints selected from 40° C., 50° C., 60° C., 70° C., and 80° C., such as a temperature from 50° C. to 70° C. The washed monocrystalline NMC is dried under vacuum for a suitable amount of time to provide dried monocrystalline NMC

Advantageously, heating the dried monocrystalline NMC at a temperature of from 500° C. to 600° C. for a time of from 1 hour to 10 hours removes impurities from the washing process and repairs particle surface structure since the particles may react with water during the washing process, thereby creating surface defects. In some aspects, the dried monocrystalline NMC is heated at a temperature within a range having endpoints selected from 500° C., 525° C., 550° C., 575° C., and 600° C. for a time within a range having endpoints selected from 1 hour, 2 hours, 3 hours, 4 hours, 5 hours, 6 hours, 7 hours, 8 hours, 9 hours, and 10 hours. In certain aspects, the temperature is from 550° C. to 600° C. and the time is from 2 hours to 6 hours, such as a temperature from 575° C. to 600° C. and a time from 3 hours to 5 hours. In any of the foregoing or following aspects, the dried monocrystalline NMC may be heated to the temperature of from 500° C. to 600° C. at a ramping rate of from 5° C./minute to 25° C./minute, such as a ramping rate within a range having endpoints selected from 5° C./minute, 10° C./minute, 15° C./minute, 20° C./minute, and 25° C./minute. In some aspects, the ramping rate is from 5° C./minute to 15° C./minute. In certain examples, the ramping rate was 10° C./minute. In any of the foregoing or following implementations, heating the dried monocrystalline NMC may be performed in a furnace under 02 flow. The 02 flow rate may be from 0 cm³/minute to 500 cm³/minute, such as a flow rate of 100 cm³/minute to 500 cm³/minute or 100 cm³/minute to 300 cm³/minute. In certain implementations, the dried monocrystalline NMC is held in the furnace at ambient temperature for a period of time (e.g., 30-90 minutes) under O₂ flow to replace all atmosphere (e.g., an inert atmosphere and/or air) in the furnace with oxygen.

In any of the foregoing aspects, subsequently cooling the dried monocrystalline NMC to ambient temperature may be performed a cooling rate of from 5° C./minute to 25° C./minute, such as a cooling rate within a range having endpoints selected from 5° C./minute, 10° C./minute, 15° C./minute, 20° C./minute, and 25° C./minute. In some aspects, the cooling rate is from 5° C./minute to 15° C./minute. In certain examples, the cooling rate was 10° C./minute.

In some implementations, the lithium compound used for the NMC synthesis is Li₂O. Li₂O is rarely used for cathode material synthesis due to its high melting point of 1438° C. Current wisdom also holds that a lithium compound needs to melt first to fully wet the solid hydroxide precursor for the reaction to occur homogeneously. However, the melting process of a lithium compound also randomly “glues” the as-formed single crystals into large clusters during calcination. The inventors have now discovered an unusual Li₂O sublimation that occurs at high temperatures of from 800° C. to 1000° C., even under 1 atm pressure. Li₂O vapor, derived from Li₂O solids, diffuses rapidly and reacts with the solid hydroxide precursor, mimicking a molten salt environment without actual melting, which facilitates single crystal growth. The chemical lithiation process continuously drives Li₂O to sublime, sintering crystals. In certain aspects, Li₂O sublimation occurs at 1 atm of pure oxygen at temperatures ≥870° C. This novel discovery allows synthesis of LiNiₓMn_{y}M_{z}Co_{1-x-y-z}O₂ without having to physically mix the solid hydroxide precursor and the lithium compound. Advantageously, relying on sublimation also eliminates the need to pre-mill the Li₂O salt since large particles of the salt can readily be used. This discovery holds great potential for synthesizing and manufacturing a broad range of single crystals for various applications.

### III. Cathodes and Lithium Ion Batteries

Monocrystalline NMC, and doped variants thereof, made by aspects of the disclosed methods may be used in cathodes, such as cathodes for lithium ion or lithium metal batteries. In some aspects, a cathode comprises monocrystalline LiNiₓMn_{y}M_{z}Co_{1-x-y-z}O₂ where M represents one or more dopant metals, 0.6≤x<1, 0.01≤y<0.2, 0≤z≤0.05, and x+y+z≤1.0. In some aspects, x is within a range having endpoints selected from 0.6, 0.65, 0.7, 0.75, 0.8, 0.85, 0.9, 0.95, and 0.99. In some implementations, 0.6≤x<1, 0.65≤x<1, 0.7≤x<1,0.75≤x<1, 0.8≤x<1, 0.85≤x<1, or 0.9≤x<1, such as from 0.6 to 0.95, from 0.65 to 0.95, from 0.7 to 0.95, from 0.75 to 0.95, or from 0.8 to 0.95. In any of the foregoing or following aspects, y may be within a range having endpoints selected from 0.01, 0.05, 0.1, 0.15, and 0.2. In some implementations, y is from 0.01 to 0.2, from 0.05 to 0.2, or from 0.08 to 0.12. In any of the foregoing or following aspects, z may be within a range having endpoints selected from 0, >0, 0.005, 0.01, 0.015, and 0.02. In some implementations, z is from 0 to 0.05, from 0 to 0.02, from >0 to 0.05, from >0 to 0.02, from 0.001 to 0.02, from 0.005 to 0.02, from 0.01 to 0.02, or 0.02. In some aspects, x=0.6 to 0.99, y=0.01 to 0.2, z=0 to 0.02, and x+y+z=0.61 to 1.0 or 0.61 to <1.0. In certain aspects, x=0.65 to 0.99, y=0.01 to 0.2, z=0 to 0.02, and x+y+z=0.66 to 1.0 or 0.66 to <1.0. In an independent aspect, x=0.65 to 0.95, y=0.01 to 0.2, z=0 to 0.02, and x+y+z=0.66 to 0.98. In still another independent embodiment, x=0.6 to 0.9, y=0.05 to 0.2, z=0 to 0.02, and x+y+z=0.65 to 0.95. In yet another independent aspect, x=0.65 to 0.9, y=0.05 to 0.2, z=0 to 0.02, and x+y+z=0.7 to 0.95. In another independent aspect, x=0.75 to 0.85, y=0.08 to 0.12, z=0, and x+y+z=0.85 to 0.92. In some examples, x is 0.7 to 0.9, such as 0.75 to 0.9 or 0.8 to 0.9; y is 0.05 to 0.15, such as 0.05 to 0.14 or 0.05 to 0.1; z is 0 to 0.02; and x+y+z is 0.8 to 0.98, such as 0.8 to 0.95. In one aspect, the NMC is LiNi_{0.8}Mn_{0.1}Co_{0.1}O₂ (NMC811). In another aspect, the NMC is LiNi_{0.76}Mn_{0.14}Co_{0.1}O₂.

In yet another aspect, the NMC is LiNi_{0.7}Mn_{0.22}Co_{0.08}O₂. In still another aspect, the NMC is LiNi_{0.9}Mn_{0.05}Co_{0.05}O₂.

When the NMC is a doped variant, 0<z≤0.05. In some aspects, z is within a range having endpoints selected from 0.001, 0.002, 0.005, 0.01, 0.012, 0.015, 0.017, 0.02, 0.03, 0.04 or 0.05. In some aspects of the doped NMC, 0.6≤x<0.99, y=0.01 to 0.25, 0<z≤0.05, and 0.61≤x+y+z 5 1.0 or 0.61≤x+y+z<1.0. In some implementations, z=0.001 to 0.05, 0.002 to 0.05, 0.005 to 0.05, 0.005 to 0.04, 0.005 to 0.03, or 0.005 to 0.02. In certain aspects, the dopant metal comprises Mg, Ti, Al, Zn, Fe, Zr, Sn, Sc, V, Cr, Cu, Ga, Y, Nb, Mo, Ru, Ta, W, Ir, or any combination thereof. In one aspect, the doped NMC is LiNi_{0.76}Mn_{0.12}Co_{0.1}Mg_{0.01}Ti_{0.01}O₂.

In any of the foregoing or following aspects, single crystals of the monocrystalline LiNixMn_{y}M_{z}Co_{1-x-y-z}O₂ may have a mean particle size of from 0.5 μm to 5 μm, such as a mean particle size within a range having endpoints selected from 0.5 μm, 1 μm, 1.5 μm, 2 μm, 2.5 μm, 3 μm, 3.5 μm, 4 μm, 4.5 μm, and 5 μm. In some aspects, the single crystals have a mean particle size of from 1 μm to 5 μm, or 1 μm to 3 μm.

In any of the foregoing or following aspects, the cathode may have a capacity >180 mAh/g. In some aspects, the cathode has a capacity >185 mAh/g, >190 mAh/g, >200 mAh/g, >210 mAh/g, >220 mAh/g, or even >230 mAh/g. In any of the foregoing or following aspects, the cathode may be operable at high voltage, e.g., a voltage of >3.8 V. In some aspects, the cathode is operable at a voltage from 2 V to 4.8 V, such as a voltage of 2.6 V to 4.3 V, 2.6 V to 4.4 V, 2.6 V to 4.5 V, 2.6 V to 4.6 V, 2.6 V to 4.7 V or 2.6 V to 4.8 V. In any of the foregoing or following aspects, the cathode may have an NMC loading of 15 mg/cm² to 30 mg/cm², such as 18 mg/cm² to 24 mg/cm² (ca. 3.5 mAh/cm² to 5.5 mAh/cm²). In some aspects, the coating weight on each side of the cathode may be from 7.5 mg/cm² to 15 mg/cm², such as 9 mg/cm² to 12 mg/cm², providing an areal capacity on each side of 3 mAh/cm² to 4.5 mAh/cm², such as 3.2 mAh/cm² to 4 mAh/cm².

In any of the foregoing or following aspects, the cathode may further comprise one or more inactive materials, such as binders and/or additives (e.g., carbon). In some aspects, the cathode may comprise from 0 wt % to 10 wt %, such as 2 wt % to 5 wt % inactive materials. Suitable binders include, but are not limited to, polyvinyl alcohol, polyvinyl fluoride, ethylene oxide polymers, polyvinylpyrrolidone, polyurethane, polytetrafluoroethylene, polyvinylidene fluoride, polyethylene, polypropylene, styrene-butadiene rubber, epoxy resin, nylon, polyimide and the like. Suitable conductive additives include, but are not limited to, carbon black, acetylene black, Ketjen black, carbon fibers (e.g., vapor-grown carbon fiber), metal powders or fibers (e.g., Cu, Ni, Al), and conductive polymers (e.g., polyphenylene derivatives). In some aspects, a slurry comprising the NMC and, optionally, inactive materials, is coated onto a support, such as aluminum foil. In certain aspects, the coating may have a thickness of 50 μm to 80 μm on each side, such as a thickness of 60 μm to 70 μm. In any of the foregoing or following aspects, the cathode may have an electrode press density of 2.5 g/cm³ to 3.5 g/cm³, such as 3 g/cm³.

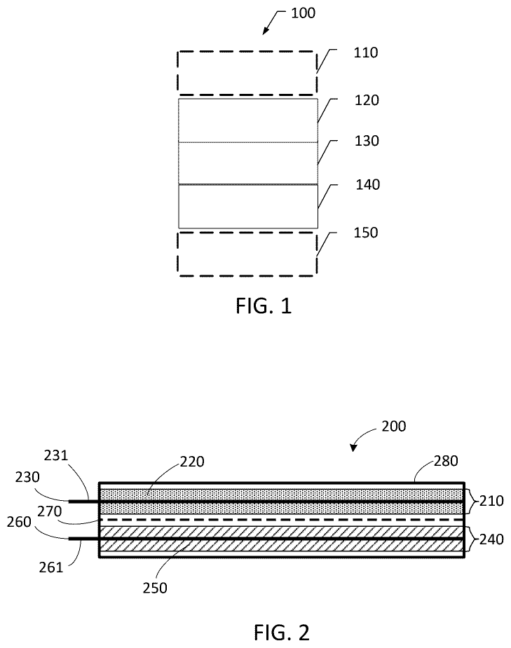

In some aspects, a lithium ion battery includes a cathode comprising monocrystalline NMC as disclosed herein, an anode, an electrolyte, and optionally a separator. FIG. 1 is a schematic diagram of one exemplary aspect of a rechargeable battery 100 including a cathode 120 as disclosed herein, a separator 130 which is infused with an electrolyte, and an anode 140. In some aspects, the battery 100 also includes a cathode current collector 110 and/or an anode current collector 150. The electrolyte may be any electrolyte that is compatible with the anode and suitable for use in a lithium ion battery.

In any of the foregoing or following aspects, the lithium ion battery may be a pouch cell. FIG. 2 is a schematic side elevation view of one aspect of a simplified pouch cell 200. The pouch cell 200 comprises an anode 210 comprising graphite material 220 and an anode current collector 230, a cathode 240 comprising an NMC cathode material 250 as disclosed herein and a cathode current collector 260, a separator 270, and a packaging material defining a pouch 280 enclosing the anode 210, cathode 240, and separator 270. The pouch 280 further encloses an electrolyte (not shown). The anode current collector 230 has a protruding tab 231 that extends external to the pouch 280, and the cathode current collector 260 has a protruding tab 261 that extends external to the pouch 280. The pouch cell weight includes all components of the cell, i.e., anode, cathode, separator, electrolyte, and pouch material. In some implementations, the pouch cell has a ratio of anode (negative electrode) areal capacity to cathode (positive electrode) areal capacity—N/P ratio—of 0.02 to 5, 0.1 to 5, 0.5 to 5, or 1 to 5. In certain implementations, the pouch cell has a ratio of electrolyte mass to cell capacity—E/C ratio—of 1 g/Ah to 6 g/Ah, such as 2 g/Ah to 6 g/Ah or 2 g/Ah to 4 g/Ah.

In any of the foregoing or following aspects, the current collectors can be a metal or another conductive material such as, but not limited to, nickel (Ni), copper (Cu), aluminum (Al), iron (Fe), stainless steel, or conductive carbon materials. The current collector may be a foil, a foam, or a polymer substrate coated with a conductive material. Advantageously, the current collector is stable (i.e., does not corrode or react) when in contact with the anode or cathode and the electrolyte in an operating voltage window of the battery. The anode and cathode current collectors may be omitted if the anode or cathode, respectively, are free standing, e.g., when the anode is a free-standing film, and/or when the cathode is a free-standing film. By “free-standing” is meant that the film itself has sufficient structural integrity that the film can be positioned without a support while providing required functionality. In any of the foregoing or following aspects, the anode may be any anode suitable for a lithium ion battery. In some aspects, the anode is lithium metal, graphite, an intercalation material, or a conversion compound. The intercalation material or conversion compound may be deposited onto a substrate (e.g., a current collector) or provided as a free-standing film, typically, including one or more binders and/or conductive additives. Suitable binders include, but are not limited to, polyvinyl alcohol, polyvinyl chloride, polyvinyl fluoride, ethylene oxide polymers, polyvinylpyrrolidone, polyurethane, polytetrafluoroethylene, polyvinylidene fluoride, polyethylene, polypropylene, styrene-butadiene rubber, epoxy resin, nylon, polyimide and the like. Suitable conductive additives include, but are not limited to, carbon black, acetylene black, Ketjen black, carbon fibers (e.g., vapor-grown carbon fiber), metal powders or fibers (e.g., Cu, Ni, Al), and conductive polymers (e.g., polyphenylene derivatives). Exemplary anodes for lithium batteries include, but are not limited to, lithium metal, carbon-based anodes (e.g., graphite, silicon-based anodes (e.g., porous silicon, carbon-coated porous silicon, carbon/silicon carbide-coated porous silicon), Mo₆S₈, TiO₂, V₂O₅, Li₄Mn₅O₁₂, Li₄Ti₅O₁₂, C/S composites, and polyacrylonitrile (PAN)-sulfur composites. In some aspects, the anode is lithium metal. In certain aspects, the anode may have a lithium coating weight on each side of a current collector of 5 mg/cm² to 15 mg/cm², providing an areal capacity on each side of 2 mAh/cm² to 5.1 mAh/cm² in the battery without a support material.

In any of the foregoing or following aspects, the separator may be glass fiber, a porous polymer film (e.g., polyethylene- or polypropylene-based material) with or without a ceramic coating, or a composite (e.g., a porous film of inorganic particles and a binder). One exemplary polymeric separator is a Celgard® K1640 polyethylene (PE) membrane. Another exemplary polymeric separator is a Celgard® 2500 polypropylene membrane. Another exemplary polymeric separator is a Celgard® 3501 surfactant-coated polypropylene membrane. The separator may be infused with the electrolyte.

In any of the foregoing or following aspects, the electrolyte may comprise a lithium active salt and a solvent. In some aspects, the lithium active salt comprises LiPF₆, LiAsF₆, LiBF₄, lithium bis(fluorosulfonyl)imide (LiFSI), lithium bis(trifluoromethanesulfonyl)imide (LiTFSI), lithium bis(oxalato)borate (LiB(C₂O₄)₂, LiBOB), lithium difluoro(oxalato)borate (LiBF₂(C₂O₄), LiDFOB), lithium bis(pentafluoroethanesulfonyl)imide (LiN(SO₂CF₂CF₃)₂, LiBETI), lithium (fluorosulfonyl trifluoromethanesulfonyl)imide (LiN(SO₂F)(SO₂CF₃), LiFTFSI), lithium (fluorosulfonyl pentafluoroethanesulfonyl)imide (LiN(SO₂F)N(SO₂CF₂CF₃), LiFBETI), lithium cyclo(tetrafluoroethylenedisulfonyl)imide (LiN(SO₂CF₂CF₂SO₂), LiCTFSI), lithium (trifluoromethanesulfonyl)(n-nonafluorobutanesulfonyl)imide (LiN(SO₂CF₃)(SO₂-n-C₄F₉), LiTNFSI), lithium cyclo-hexafluoropropane-1,3-bis(sulfonyl)imide, or any combination thereof. The solvent is any nonaqueous solvent suitable for use with the lithium active salt, lithium metal anode, and packaging material. Exemplary solvents include, but are not limited to, triethyl phosphate, trimethyl phosphate, tributyl phosphate, triphenyl phosphate, tris(2,2,2-trifluoroethyl) phosphate, bis(2,2,2-trifluoroethyl) methyl phosphate; trimethyl phosphite, triphenyl phosphite, tris(2,2,2-trifluoroethyl) phosphite; dimethyl methylphosphonate, diethyl ethylphosphonate, diethyl phenylphosphonate, bis(2,2,2-trifluoroethyl) methylphosphonate; hexamethylphosphoramide; hexamethoxyphosphazene, hexafluorophosphazene, 1,2-dimethoxyethane (DME), 1,3-dioxolane (DOL), tetrahydrofuran (THF), allyl ether, dimethyl carbonate (DMC), ethyl methyl carbonate (EMC), diethyl carbonate (DEC), ethylene carbonate (EC), propylene carbonate (PC), ethyl propanoate (EP), vinylene carbonate (VC), fluoroethylene carbonate (FEC), 4-vinyl-1,3-dioxolan-2-one (vinyl ethylene carbonate, VEC), 4-methylene-1,3-dioxolan-2-one (methylene ethylene carbonate, MEC), 4,5-dimethylene-1,3-dioxolan-2-one, dimethyl sulfoxide (DMSO), dimethyl sulfone (DMS), ethyl methyl sulfone (EMS), ethyl vinyl sulfone (EVS), tetramethylene sulfone (i.e. sulfolane, TMS), trifluoromethyl ethyl sulfone (FMES), trifluoromethyl isopropyl sulfone (FMIS), trifluoropropyl methyl sulfone (FPMS), diethylene glycol dimethyl ether (diglyme), triethylene glycol dimethyl ether (triglyme), tetraethylene glycol dimethyl ether (tetraglyme), methyl butyrate, ethyl propionate, gamma-butyrolactone, acetonitrile (AN), succinonitrile (SN), adiponitrile, triallyl amine, triallyl cyanurate, triallyl isocyanurate, or any combination thereof. In some aspects, the solvent comprises a flame retardant compound. The flame retardant compound may comprise the entire solvent. Alternatively, the solvent may comprise at least 5 wt % of the flame retardant compound in combination with one or more additional solvents and/or diluents. Exemplary flame retardant compounds include, but are not limited to, triethyl phosphate, trimethyl phosphate, tributyl phosphate, triphenyl phosphate, tris(2,2,2-trifluoroethyl) phosphate, bis(2,2,2-trifluoroethyl) methyl phosphate; trimethyl phosphite, triphenyl phosphite, tris(2,2,2-trifluoroethyl) phosphite; dimethyl methylphosphonate, diethyl ethylphosphonate, diethyl phenylphosphonate, bis(2,2,2-trifluoroethyl) methylphosphonate; hexamethylphosphoramide; hexamethoxyphosphazene, hexafluorophosphazene, and combinations thereof. In some aspects, the electrolyte has a lithium active salt concentration of 0.5 M to 8 M, such as a concentration of 1 M to 8 M, 1 M to 6 M, or 1 M to 5 M. In some examples, the electrolyte comprises LiPF₆ in a carbonate solvent, such as 1.0 M LiPF₆ in EC/EMC.

In some aspects, the electrolyte is a localized superconcentrated electrolyte (LSE), also referred to as a localized high concentration electrolyte. An LSE includes an active salt, a solvent in which the active salt is soluble, and a diluent, wherein the active salt has a solubility in the diluent at least 10 times less than a solubility of the active salt in the solvent. In an LSE, lithium ions remain associated with solvent molecules after addition of the diluent. The anions are also in proximity to, or associated with, the lithium ions. Thus, localized regions of solvent-cation-anion aggregates are formed. In contrast, the lithium ions and anions are not associated with the diluent molecules, which remain free in the solution. In an LSE, the electrolyte as a whole is not a concentrated electrolyte, but there are localized regions of high concentration where the lithium cations are associated with the solvent molecules. There are few to no free solvent molecules in the diluted electrolyte, thereby providing the benefits of a superconcentrated electrolyte without the associated disadvantages. The solubility of the active salt in the solvent (in the absence of diluent) may be greater than 3 M, such as at least 4 M or at least 5 M. In some aspects, the solubility and/or concentration of the active salt in the solvent is of 3 M to 10 M, such as from 3 M to 8 M, from 4 M to 8 M, or from 5 M to 8 M. However, in some implementations, the molar concentration of the active salt in the LSE, as a whole, is of 0.5 M to 3 M, 0.5 M to 2 M, 0.75 M to 2 M, or 0.75 M to 1.5 M.

Exemplary salts and solvents for LSEs are those disclosed above. In some aspects, the diluent comprises a fluoroalkyl ether (also referred to as a hydrofluoroether (HFE)), a fluorinated orthoformate, or a combination thereof. Exemplary diluents include, but are not limited to, 1,1,2,2-tetrafluoroethyl-2,2,3,3-tetrafluoropropyl ether (TTE), bis(2,2,2-trifluoroethyl) ether (BTFE), 1,1,2,2,-tetrafluoroethyl-2,2,2-trifluoroethyl ether (TFTFE), methoxynonafluorobutane (MOFB), ethoxynonafluorobutane (EOFB), tris(2,2,2-trifluoroethyl)orthoformate (TFEO), tris(hexafluoroisopropyl)orthoformate (THFiPO), tris(2,2-difluoroethyl)orthoformate (TDFEO), bis(2,2,2-trifluoroethyl) methyl orthoformate (BTFEMO), tris(2,2,3,3,3-pentafluoropropyl)orthoformate (TPFPO), tris(2,2,3,3-tetrafluoropropyl)orthoformate (TTPO), or any combination thereof. In certain aspects where the diluent and solvent are immiscible, the electrolyte may further include a bridge solvent having a different composition than the solvent and a different composition than the diluent, wherein the bridge solvent is miscible with the solvent and with the diluent. Exemplary bridge solvents include acetonitrile, dimethyl carbonate, diethyl carbonate, propylene carbonate, dimethyl sulfoxide, 1,3-dioxolane, dimethoxyethane, diglyme (bis(2-methoxyethyl) ether), triglyme (triethylene glycol dimethyl ether), tetraglyme (tetraethylene glycol dimethyl ether), or any combination thereof. Additional information regarding LSEs may be found in US 2018/0254524 A1, US 2018/0251681 A1, and US 2019/148775 A1, the relevant portion of each being incorporated in herein by reference.

In any of the foregoing or following aspects, the battery may be operable at a rate of up to 3C, such as a rate of 0.1 C to 3 C. In any of the foregoing or following aspects, the battery is a lithium ion battery and may demonstrate an initial coulombic efficiency of at least 80%, at least 85% or at least 90%, such as 80-100%, 85-100%, or 85-95%. In any of the foregoing or following aspects, the lithium ion battery may have a capacity retention of at least 70%, at least 75%, or at least 80% after at least 100 cycles, at least 200 cycles, at least 300 cycles, at least 400 cycles, at least 500 cycles, at least 600 cycles, at least 650 cycles, at least 700 cycles, or even at least 750 cycles. In some aspects, the capacity retention is 70-90% after 600 cycles, such as 80-90% after 600 cycles. In certain aspects, the capacity retention is 70-90%, such as 70-80%, after 700 cycles or even after 750 cycles. In one example, single NMC (LiNi_{0.8}Mn_{0.1}Co_{0.1}O₂) crystals derived from Li₂O salts demonstrated outstanding cycling stability with a capacity retention of greater than 85% after 675 cycles in full cells. The cathode produced using the disclosed method exhibits comparable stability over extensive cycling to conventional Ni-rich cathodes prepared with polycrystalline and/or monocrystalline NMC. Notably, the disclosed method significantly shortens the heating time to as little as one minute, thereby reducing the manufacturing cost of the Ni-rich cathode.

### IV. Representative Aspects

Certain representative aspects are exemplified in the following numbered paragraphs.
1. A method for synthesizing monocrystalline LiNiₓMn_{y}M_{z}Co_{1-x-y-z}O₂, comprising: synthesizing LiNiₓMn_{y}M_{z}Co_{1-x-y-z}O₂ by heating a solid hydroxide precursor comprising NiₓMn_{y}M_{z}Co_{1-x-y-z}(OH)₂ and a molar excess of a lithium compound in an oxygen-containing atmosphere at a temperature T for an effective period of time t to form monocrystalline lithium nickel manganese cobalt oxide (NMC) having a formula LiNiₓMn_{y}M_{z}Co_{1-x-y-z}O₂, where M represents one or more dopant metals, 0.6≤x<1, 0.01≤y<0.2, 0≤z≤0.05, and x+y+z<1.0.
2. The method of paragraph 1, wherein the solid hydroxide precursor and the lithium compound are heated in the oxygen-containing atmosphere to the temperature Tat a ramping rate of from 2° C./minute to 10° C./minute.
3. The method of paragraph 1 or paragraph 2, wherein the lithium compound comprises lithium oxide, lithium hydroxide, lithium carbonate, lithium peroxide, or any combination thereof.
4. The method of paragraph 1 or paragraph 2, wherein the lithium compound comprises lithium oxide, lithium hydroxide, or a combination thereof.
5. The method of any one of paragraphs 1-4, wherein a lithium compound:solid hydroxide precursor molar ratio is from 1.05:1 to 5:1.
6. The method of paragraph 5, wherein the lithium compound:solid hydroxide precursor molar ratio is from 1.05:1 to 1.2:1.
7. The method of any one of paragraphs 1-6, wherein the temperature Tis from 850° C. to 1000° C.
8. The method of any one of paragraphs 1-7, wherein the time t is from 1 minute to 12 hours.
9. The method of any one of paragraphs 1-6, wherein: the temperature Tis from 920° C. to 1000° C.; and the time t is from 1 minute to 2 hours.
10. The method of any one of paragraphs 1-6, wherein: the temperature Tis from 950° C. to 1000° C.; and the time t is from 1 minute to 1 hour.
11. The method of any one of paragraphs 1-10, wherein heating the solid hydroxide precursor and the lithium compound in the oxygen-containing atmosphere comprises heating the solid hydroxide precursor and the lithium compound under an O₂ flow at a flow rate of 0 cm³/minute to 500 cm³/minute.
12. The method of any one of paragraphs 1-11, further comprising a post synthesis process of cooling the monocrystalline NMC from the temperature T to ambient temperature at a temperature reduction rate of from 2° C./minute to 10° C./minute.
13. The method of any one of paragraphs 1-12, further including a post-synthesis process comprising: washing the monocrystalline NMC with water to provide washed monocrystalline NMC; drying the washed monocrystalline NMC at a temperature of from 40° C. to 80° C. under vacuum to provide dried monocrystalline NMC; heating the dried monocrystalline NMC at a temperature of from 500° C. to 600° C. for a time of from 1 hour to 10 hours under oxygen flow at a flow rate of from 0 cm³/min to 500 cm³/min; and subsequently cooling the dried monocrystalline NMC to ambient temperature.
14. The method of paragraph 13, wherein: (i) the dried monocrystalline NMC is heated at a ramping rate of from 5° C./minute to 15° C./minute to the temperature of from 500° C. to 600° C.; or (ii) the dried monocrystalline NMC is cooled to ambient temperature at a rate of from 5° C./minute to 15° C./minute; or (iii) both (i) and (ii).
15. The method of any one of paragraphs 1-14, further comprising a pre-synthesis process of combining the solid hydroxide precursor with the molar excess of the lithium compound under an inert atmosphere.
16. The method of paragraph 15, wherein combining the solid hydroxide precursor with the lithium compound comprises forming a hydroxide mixture comprising the solid hydroxide precursor and the lithium compound.
17. The method of any one of paragraphs 1-16, wherein: x=0.6 to 0.9; y=0.05 to 0.2; z=0 to 0.02; and x+y+z=0.7 to 0.95.
18. The method of any one of paragraphs 1-16, wherein: x=0.7 to 0.9; y=0.05 to 0.15; z=0 to 0.02; and x+y+z=0.8 to 0.98.
19. The method of any one of paragraphs 1-18, wherein z is zero.
20. The method of paragraph 19, wherein: x=0.75 to 0.85; y=0.08 to 0.12; and x+y=0.85 to 0.92.
21. The method of any one of paragraphs 1-18, wherein: 0<z 5 0.05; and the dopant metal M comprises Mg, Ti, Al, Zn, Fe, Zr, Sn, Sc, V, Cr, Cu, Ga, Y, Nb, Mo, Ru, Ta, W, Ir, or any combination thereof.
22. The method of any one of paragraphs 1-21, wherein single crystals of the monocrystalline NMC have a mean particle size of from 1 μm to 5 μm.
23. The method of any one of paragraphs 1-22, wherein synthesizing monocrystalline LiNiₓMn_{y}M_{z}Co_{1-x-y-z}O₂ is performed in the absence of liquids.
24. The method of any one of paragraphs 1-23, wherein synthesizing monocrystalline LiNiₓMn_{y}M_{z}Co_{1-x-y-z}O₂ does not include a step of converting the solid hydroxide precursor to a solid oxide precursor prior to heating in the oxygen-containing atmosphere at the temperature T for the effective period of time t.
25. The method of any one of paragraphs 1-24, wherein the lithium compound is Li₂O, and heating the solid hydroxide precursor and the molar excess of the Li₂O in the oxygen-containing atmosphere at the temperature T effects Li₂O sublimation with resulting Li₂O vapor reacting with the solid hydroxide precursor to form the monocrystalline LiNiₓMn_{y}M_{z}Co_{1-x-y-z}O₂.

### V. Examples

### Example 1

Under an argon atmosphere, (i) 2.5 g Ni_{0.8}Mn_{0.1}Co_{0.1}(OH)₂ (TMOH811) and (ii) a lithium compound—0.45 g Li₂O or 0.7 g LiOH or 1.1 g Li₂CO₃—were combined in a container. The Li: transition metal hydroxide (TMOH811) molar ratio was ˜1.1:1. Plastic balls (10 g) as a mixing aid were added to the container and the container was sealed. The components were mixed for 2 hours with a roller mixer.

Subsequently, the container was opened under an argon atmosphere, the plastic balls were removed, and the TMOH811/Li compound mixture was transferred to an alumina crucible. In other non-limiting examples, the solid hydroxide precursor is Ni_{0.76}Mn_{0.14}Co_{0.1}(OH)₂, Ni_{0.7}Mn_{0.22}Co_{0.08}(OH)₂, Ni_{0.9}Mn_{0.05}Co_{0.05}(OH)₂, or Ni_{0.76}Mn_{0.12}Co_{0.1}Mg_{0.01}Ti_{0.01}(OH)₂.

A furnace was purged with 02 (200 cm³/min) for 30 minutes, and the crucible was placed into the furnace. Under continued oxygen flow, the crucible was held in the furnace for one hour at ambient temperature. The TMOH811/Li compound mixture was heated from ambient temperature to 900° C., 920° C., or 980° C. at a ramping rate of 5° C./min. The TMOH811/Li compound mixture was held in the furnace at 900° C. for 10 hours, or at 920° C. for 2 hours, or at 980° C. for 1 minute to provide LiNi_{0.8}Mn_{0.1}Co_{0.1}O₂. The LiNi_{0.8}Mn_{0.1}Co_{0.1}O₂ was then cooled to ambient temperature with a temperature reduction rate of 5° C./min.

The crucible was removed from the furnace. The LiNi_{0.8}Mn_{0.1}Co_{0.1}O₂ was ground and then washed with 40 g deionized water. The washed LiNi_{0.8}Mn_{0.1}Co_{0.1}O₂ was dried under vacuum at 60° C. for 10 hours. The dried LiNi_{0.8}Mn_{0.1}Co_{0.1}O₂ was then placed into an alumina crucible, and placed into the furnace. The crucible was held in the furnace for one hour at ambient temperature. The dried LiNi_{0.8}Mn_{0.1}Co_{0.1}O₂ was heated to 580° C. at a ramping rate of 10° C./minute, and held at 580° C. for 4 hours under oxygen flow at 200 cm³/min. The annealed LiNi_{0.8}Mn_{0.1}Co_{0.1}O₂ was then cooled to ambient temperature with a temperature reduction rate of 10° C./min. The washing process may be used to remove any excess base from the LiNi_{0.8}Mn_{0.1}Co_{0.1}O₂. The subsequent drying process and annealing at 580° C. removes any impurities from the washing process and repairs particle surface structure since some reaction of the LiNi_{0.8}Mn_{0.1}Co_{0.1}O₂ with water may occur during the washing process. The LiNi_{0.8}Mn_{0.1}Co_{0.1}O₂ was milled/crushed and sieved with 200-600 mesh, and collected for further evaluation. The process of washing, drying, and heating at 580° C. may be omitted when the Li/TM molar ratio is less than 1.1.

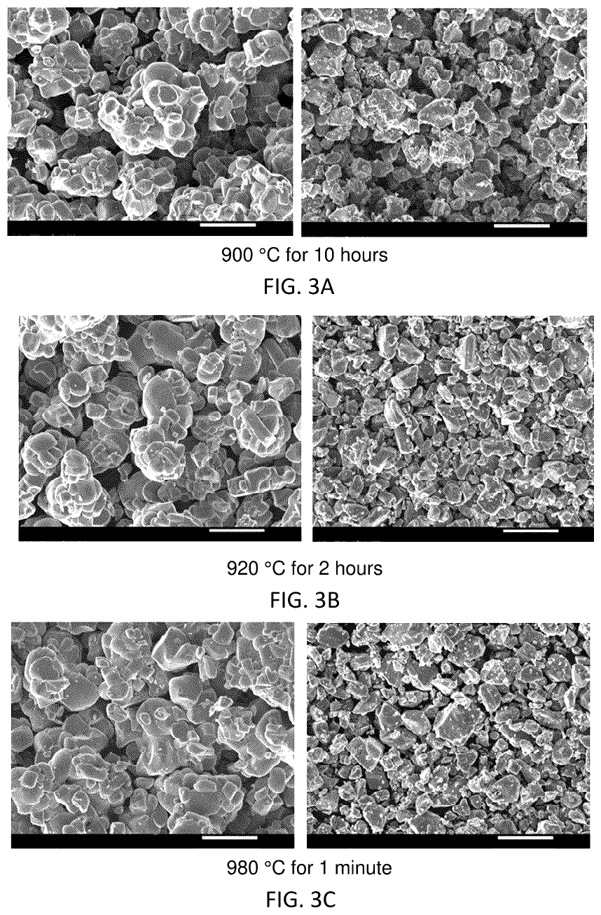

FIGS. 3A-3C are scanning electron microscopy (SEM) images of the LiNi_{0.8}Mn_{0.1}Co_{0.1}O₂ (NMC811) prepared with Li₂O at 900° C. for 10 hours (FIG. 3A), 920° C. for 2 hours (FIG. 3B), or 980° C. for 1 minute (FIG. 3C); size bar=5 μm. In each set of images, the left image is as-synthesized monocrystalline NMC811, and the right image is the crushed NMC811. The particle size of the as-synthesized monocrystalline NMC811 ranged from 1 μm to 3 μm.

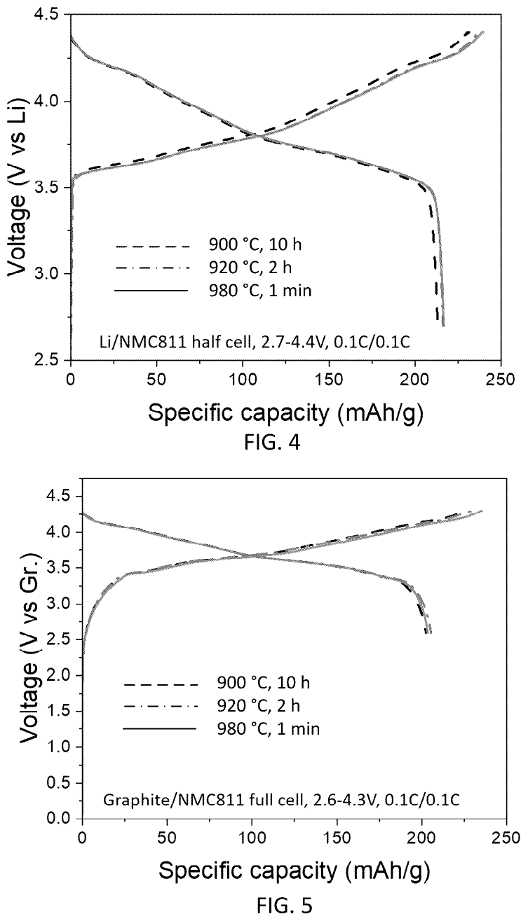

The NMC811 prepared with Li₂O at 900° C., 920° C., and 980° C. was evaluated in Li/NMC811 half cells over voltage window of 2.7 V to 4.4 V with charge/discharge rates of 0.1 C/0.1 C. The electrolyte was a mixture of lithium bis(fluorosulfonyl imide (LiFSI, Gotion, Fremont, CA), ethyl propionate (EP, Sigma-Aldrich, St. Louis, MO), ethylene carbonate (EC), and 1,1,2,2-tetrafluoroethyl-2,2,3,3-tetrafluoropropyl ether (TTE) in a molar ratio of 1:2.8:0.2:1 with addition of 1 wt % lithium difluorophosphate (LiPO₂F₂) (Kim et al., ACS Energy Letters 2024, 9:2318-2325). The results are shown in FIG. 4. Table 1 presents the specific capacity, initial coulombic efficiency, and areal capacity of the three monocrystalline NMC811 products in the Li/NMC811 half cells.

TABLE 1

| | | Initial | |
|---|---|---|---|
| | Specific | Coulombic | Areal |
| NMC811 | Capacity | Efficiency | Capacity |
| 900° C., 10 h | 213.2 mAh/g | 92.1% | 3.30 mAh/cm² |
| 920° C., 2 h | 216.2 mAh/g | 91.1% | 3.19 mAh/cm² |
| 980° C., 1 min | 216.7 mAh/g | 90.4% | 3.44 mAh/cm² |

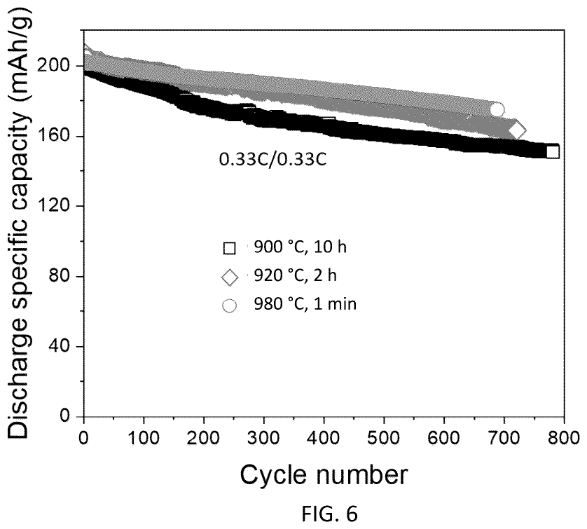

The three NMC811 products prepared with Li₂O were further evaluated in graphite/NMC811 full cells with the same electrolyte over a voltage window of 2.6 V to 4.3 V with charge/discharge rates of 0.1 C/0.1 C. The specific capacity and discharge specific capacity were evaluated; the results are shown in FIG. 5. FIG. 6 shows the cycling performance of the NMC811 products over 700-800 cycles. Table 2 presents the specific capacity, initial coulombic efficiency, areal capacity, and cycle life of the three monocrystalline NMC811 products in the graphite/NMC811 full cells.

TABLE 2

| | | Initial | | |
|---|---|---|---|---|
| | Specific | Coulombic | Areal | |
| NMC811 | Capacity | Efficiency | Capacity | Cycle Life |
| 900° C., 10 h | 202.4 mAh/g | 89.8% | 3.39 mAh/cm² | 781 cycles |
| | | | | @ 75.6% |
| 920° C., 2 h | 205.4 mAh/g | 89.2% | 3.37 mAh/cm² | 721 cycles |
| | | | | @ 79.9% |
| 980° C., 1 min | 203.6 mAh/g | 86.5% | 3.27 mAh/cm² | 688 cycles |
| | | | | @ 86.5% |

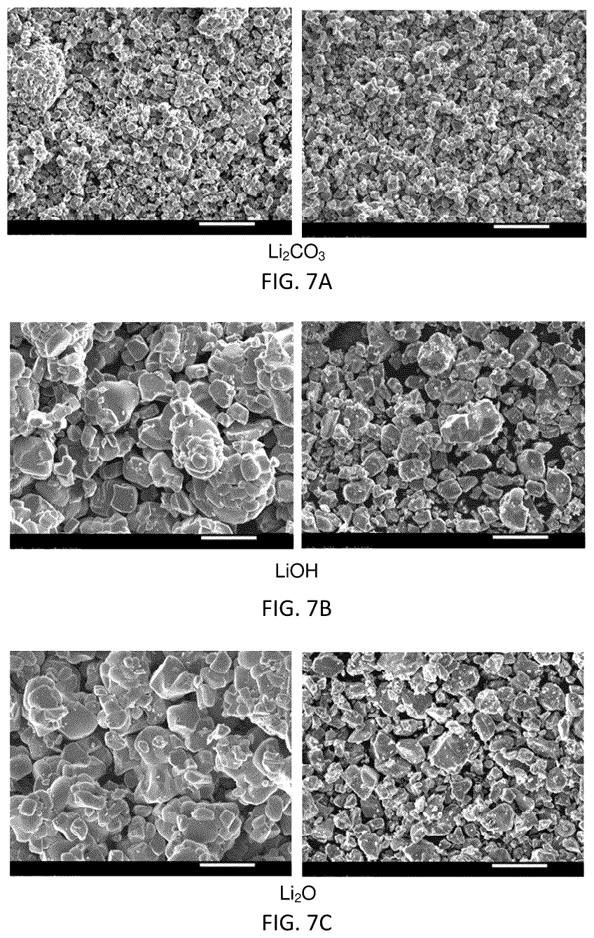

FIGS. 7A-7B are SEM images of the as-synthesized (left image) and crushed (right image) LiNi_{0.8}Mn_{0.1}Co_{0.1}O₂ (NMC811) prepared with Li₂CO₃ (FIG. 7A), LiOH (FIG. 7B), and Li₂O (FIG. 7C) at 980° C. for 1 minute; size bar=5 μm. In each set of images, the left image is as-synthesized monocrystalline NMC811, and the right image is the crushed NMC811. The particle size of as-synthesized monocrystalline NMC811 with LiOH and Li₂O ranged from 1 μm to 3 μm. Small particle size less than 1 μm was observed for NMC811 from Li₂CO₃.

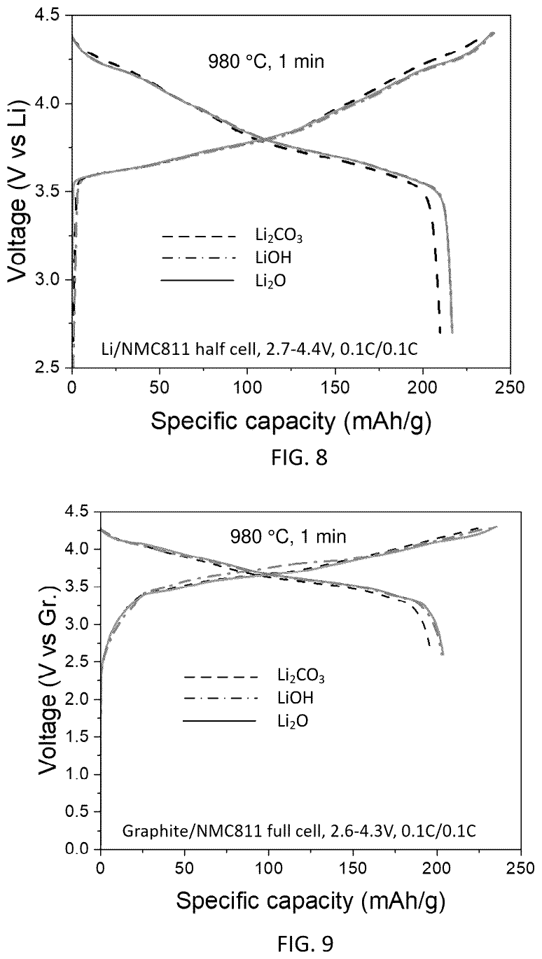

The NMC811 prepared with Li₂CO₃, LiOH, and Li₂O at 980° C. was evaluated in Li/NMC811 half cells over voltage window of 2.7 V to 4.4 V with charge/discharge rates of 0.1 C/0.1 C. The results are shown in FIG. 8. Table 3 presents the specific capacity, initial coulombic efficiency, and areal capacity of the three monocrystalline NMC811 products in the Li/NMC811 half cells.

TABLE 3

| | | Initial | |
|---|---|---|---|
| | Specific | Coulombic | Areal |
| NMC811 | Capacity | Efficiency | Capacity |
| Li₂CO₃ | 209.8 mAh/g | 88.5% | 3.35 mAh/cm² |
| LiOH | 216.5 mAh/g | 90.0% | 2.95 mAh/cm² |
| Li₂O | 216.7 mAh/g | 90.4% | 3.44 mAh/cm² |

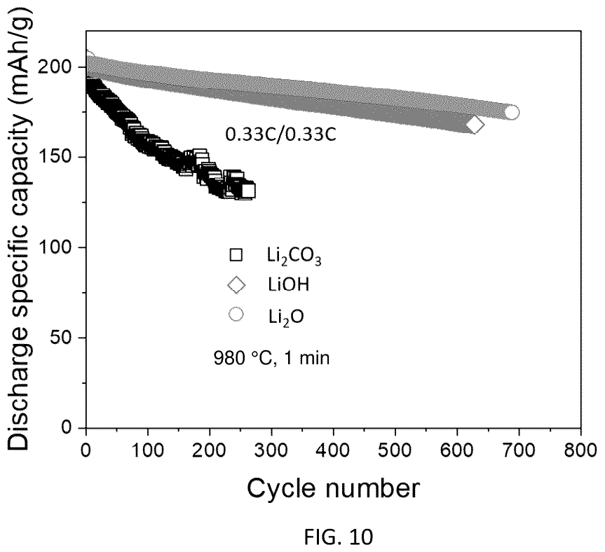

The three NMC811 products prepared with Li₂CO₃, LiOH, and Li₂O were further evaluated in graphite/NMC811 full cells over a voltage window of 2.6 V to 4.3 V with charge/discharge rates of 0.1 C/0.1 C. The specific capacity and discharge specific capacity were evaluated; the results are shown FIG. 9. FIG. 10 shows the cycling performance of the NMC811 products over 700-800 cycles. Table 4 presents the specific capacity, initial coulombic efficiency, areal capacity, and cycle life of the three monocrystalline NMC811 products in the graphite/NMC811 full cells. The best cycling performance was obtained with monocrystalline NMC811 prepared with Li₂O and heated at 980° C. for 1 minute.

TABLE 4

| | | Initial | | |
|---|---|---|---|---|
| | Specific | Coulombic | Areal | |
| NMC811 | Capacity | Efficiency | Capacity | Cycle Life |
| Li₂CO₃ | 196.4 mAh/g | 86.0% | 3.27 mAh/cm² | 263 cycles |
| | | | | @ 68.1% |
| LiOH | 202.7 mAh/g | 86.2% | 3.45 mAh/cm² | 628 cycles |
| | | | | @ 83.5% |
| Li₂O | 203.6 mAh/g | 86.5% | 3.27 mAh/cm² | 688 cycles |
| | | | | @ 86.5% |

### Example 2

Under an argon atmosphere, solid hydroxide precursor (e.g., TMOH811) and Li₂O are placed in a vessel (e.g., a crucible) without mixing. In some implementations, the vessel may include two or more compartments (e.g., a small crucible within a larger crucible) such that TMOH811 and Li₂O are placed into separate compartments within the vessel.

A furnace is purged with 02, and the vessel is placed into the furnace. Under continued oxygen flow, the vessel is held in the furnace for a period of time at ambient temperature. The solid hydroxide precursor and Li₂O are heated from ambient temperature to 900° C. to 1000° C. at a ramping rate of 2° C./minute to 10° C./minute. The solid hydroxide precursor and Li₂O are held in the furnace at 900° C. to 1000° C. for a time of from 1 minute to 10 hours to provide LiNiₓMn_{y}M_{z}Co_{1-x-y-z}O₂. It is believed that at the furnace temperature, the Li₂O sublimes and the Li₂O vapor reacts with the solid hydroxide precursor to form LiNiₓMn_{y}M_{z}Co_{1-x-y-z}O₂. The LiNiₓMn_{y}M_{z}Co_{1-x-y-z}O₂ is then cooled to ambient temperature with a temperature reduction rate of 2° C./minute to 10° C./minute.

The vessel is removed from the furnace. In some examples, the LiNiₓMn_{y}M_{z}Co_{1-x-y-z}O₂ is ground to small particles and screened with 400 mesh sieves, and then washed with deionized water. The washed LiNixMn_{y}M_{z}Co_{1-x-y-z}O₂ is dried under vacuum. The dried LiNiₓMn_{y}M_{z}Co_{1-x-y-z}O₂ is placed into a crucible, and placed into the furnace. The crucible is held in the furnace for a period of time at ambient temperature. The dried LiNiₓMn_{y}M_{z}Co_{1-x-y-z}O₂ is heated to a temperature of from 500° C. to 600° C. at a ramping rate of 5° C./minute to 15° C./minute, and held at 500° C. to 600° C. for 1 hour to 10 hours to repair the surface damage of the materials in washing process. The annealed LiNiₓMn_{y}M_{z}Co_{1-x-y-z}O₂ is cooled to ambient temperature with a temperature reduction rate of 5° C./minute to 15° C./minute. The LiNiₓMn_{y}M_{z}Co_{1-x-y-z}O₂ is milled/crushed and sieved. The process of washing, drying, and heating may be omitted when the Li/TM molar ratio is less than 1.1.

In view of the many possible aspects to which the principles of the present disclosure may be applied, it should be recognized that the illustrated aspects are only preferred examples of the disclosure and should not be taken as limiting the scope of the present disclosure. Rather, the scope is defined by the following claims. We therefore claim as our invention all that comes within the scope and spirit of these claims.

We claim:

1. A method for synthesizing monocrystalline LiNixMn_{y}M_{z}Co_{1-x-y-z}O₂, comprising:
synthesizing LiNiₓMn_{y}M_{z}Co_{1-x-y-z}O₂ by heating a solid hydroxide precursor comprising NiₓMn_{y}M_{z}Co_{1-x-y-z}(OH)₂ and a molar excess of a lithium compound in an oxygen-containing atmosphere at a temperature T for an effective period of time t to form monocrystalline lithium nickel manganese cobalt oxide (NMC) having a formula LiNiₓMn_{y}M_{z}Co_{1-x-y-z}O₂,
where M represents one or more dopant metals,
$$0.6 \leq x < 1 ,$$
$$0.01 \leq y < 0.2 ,$$
$$0 \leq z \leq 0.05 , and$$
$$x + y + z \leq 1. .$$

2. The method of claim 1, wherein the solid hydroxide precursor and the lithium compound are heated in the oxygen-containing atmosphere to the temperature Tat a ramping rate of from 2° C./minute to 10° C./minute.

3. The method of claim 1, wherein the lithium compound comprises lithium oxide, lithium hydroxide, lithium carbonate, lithium peroxide, or any combination thereof.

4. The method of claim 1, wherein a lithium compound:solid hydroxide precursor molar ratio is from 1.05:1 to 5:1.

5. The method of claim 1, wherein the temperature T is from 850° C. to 1000° C.

6. The method of claim 1, wherein the time t is from 1 minute to 12 hours.

7. The method of claim 1, wherein heating the solid hydroxide precursor and the lithium compound in the oxygen-containing atmosphere comprises heating the solid hydroxide precursor and the lithium compound under an O₂ flow at a flow rate of 0 cm³/minute to 500 cm³/minute.

8. The method of claim 1, further comprising a post synthesis process of cooling the monocrystalline NMC from the temperature T to ambient temperature at a temperature reduction rate of from 2° C./minute to 10° C./minute.

9. The method of claim 1, further including a post-synthesis process comprising:
washing the monocrystalline NMC with water to provide washed monocrystalline NMC;
drying the washed monocrystalline NMC at a temperature of from 40° C. to 80° C. under vacuum to provide dried monocrystalline NMC;
heating the dried monocrystalline NMC at a temperature of from 500° C. to 600° C. for a time of from 1 hour to 10 hours under oxygen flow at a flow rate of from 0 cm³/min to 500 cm³/min; and
subsequently cooling the dried monocrystalline NMC to ambient temperature.

10. The method of claim 9, wherein:
(i) the dried monocrystalline NMC is heated at a ramping rate of from 5° C./minute to 15° C./minute to the temperature of from 500° C. to 600° C.; or
(ii) the dried monocrystalline NMC is cooled to ambient temperature at a rate of from 5° C./minute to 15° C./minute; or
(iii) both (i) and (ii).

11. The method of claim 1, further comprising a pre-synthesis process of combining the solid hydroxide precursor with the molar excess of the lithium compound under an inert atmosphere.

12. The method of claim 11, wherein combining the solid hydroxide precursor with the lithium compound comprises forming a hydroxide mixture comprising the solid hydroxide precursor and the lithium compound.

13. The method of claim 1, wherein:
$$x = 0.6 to 0.9 ;$$
$$y = 0.05 to 0.2 ;$$
$$z = 0 to 0.02 ; and$$
$$x + y + z = 0.7 to 0.95 .$$

14. The method of claim 1, wherein z is zero.

15. The method of claim 14, wherein:
$$x = 0.75 to 0.85 ;$$
$$y = 0.08 to 0.12 ; and$$
$$x + y = 0.85 to 0.92 .$$

16. The method of claim 1, wherein:
0<z≤0.05; and
the dopant metal M comprises Mg, Ti, Al, Zn, Fe, Zr, Sn, Sc, V, Cr, Cu, Ga, Y, Nb, Mo, Ru, Ta, W, Ir, or any combination thereof.

17. The method of claim 1, wherein single crystals of the monocrystalline NMC have a mean particle size of from 1 μm to 5 μm.

18. The method of claim 1, wherein synthesizing monocrystalline LiNiₓMn_{y}M_{z}Co_{1-x-y-z}O₂ is performed in the absence of liquids.

19. The method of claim 1, wherein synthesizing monocrystalline LiNiₓMn_{y}M_{z}Co_{1-x-y-z}O₂ does not include a step of converting the solid hydroxide precursor to a solid oxide precursor prior to heating in the oxygen-containing atmosphere at the temperature T for the effective period of time t.

20. The method of claim 1, wherein the lithium compound is Li₂O, and heating the solid hydroxide precursor and the molar excess of the Li₂O in the oxygen-containing atmosphere at the temperature T effects Li₂O sublimation with resulting Li₂O vapor reacting with the solid hydroxide precursor to form the monocrystalline LiNiₓMn_{y}M_{z}Co_{1-x-y-z}O₂.
